(19) United States
(12) Patent Application Publication
(10) Pub. No.: US 2026/0340367 A1
(43) Pub. Date: Oct. 29, 2026

(54) FRACTIONAL-BIT QUANTIZATION AND DEPLOYMENT OF CONVOLUTIONAL NEURAL NETWORK MODELS

(71) Applicant: Intel Corporation, Santa Clara, CA (US)

(72) Inventors: Anbang Yao, Beijing (CN); Yi Yang, Shanghai (CN); Feng Chen, Shanghai (CN); Wanglei Shen, Shanghai (CN); Ming Lu, Beijing (CN); Liang Cheng, Shanghai (CN); Yu Zhang, Beijing (CN); Miaoming Liu, Beijing (CN); Bo Liu, Beijing (CN); Yurong Chen, Beijing (CN)

(73) Assignee: Intel Corporation, Santa Clara, CA (US)

(21) Appl. No.: 18/995,651

(22) PCT Filed: Aug. 23, 2022
(86) PCT No.: PCT/CN2022/114114

§ 371 Date: Jan. 16, 2025

(51) Int. Cl. G06N 3/0495; G06N 3/0464

(52) U.S. Cl. CPC G06N 3/0495; G06N 3/0464

(57) ABSTRACT

The disclosure relates to fractional-bit network quantization and deployment of CNN models. An AI accelerator, including: an input buffer configured to buffer an input image; a weight buffer configured to buffer convolutional kernel indexes for a convolutional layer of a CNN model; a kernel pattern buffer configured to buffer a 1-bit convolutional kernel subset for the convolutional layer of the CNN model, wherein the 1-bit convolutional kernel subset includes 2^{τ} 1-bit convolutional kernels with a size of K×K; a PE array including one or more PE nodes, each of which is configured to generate convolutional results of an image region of the input image and 1-bit convolutional kernels corresponding to the convolutional kernel indexes in the 1-bit convolutional kernel subset; and an output buffer configured to buffer convolutional results of respective image regions of the input image and the 1-bit convolutional kernels corresponding to the convolutional kernel indexes.

### TECHNICAL FIELD

Embodiments described herein generally relate to the field of neural network, and more particularly relate to fractional-bit network quantization and deployment of Convolutional Neural Network (CNN) models.

### BACKGROUND

Convolutional Neural Network (CNN) models are powerful learning models that achieve state-of-the-art performance on many computer vision tasks. The CNN models include an input layer, an output layer and at least one hidden layer in between and use sophisticated mathematical modeling to process data transferred among these network layers.

### BRIEF DESCRIPTION OF THE DRAWINGS

The various advantages of the embodiments will become apparent to one skilled in the art by reading the following specification and appended claims, and by referencing the following drawings, in which:

FIGS. 1A-1B are flow diagrams illustrating methods for quantizing a CNN model in accordance with some embodiments of the disclosure;

FIG. 2 is a diagram illustrating speed up of a fractional-bit CNN model against a 1-bit CNN model in accordance with some embodiments of the disclosure;

FIG. 3 is a block diagram illustrating a fractional-bit Artificial Intelligence (AI) accelerator for deployment of a fractional-bit CNN model in accordance with some embodiments of the disclosure;

FIG. 4 is a block diagram illustrating a Processing Engine (PE) node in the fractional-bit AI accelerator shown in FIG. 3 in accordance with some embodiments of the disclosure;

FIG. 5 is a block diagram illustrating components, according to some example embodiments of the disclosure, able to read instructions from a machine-readable or computer-readable medium and perform any one or more of the methodologies discussed herein;

FIG. 6 is a block diagram of an example processor platform in accordance with some embodiments of the disclosure; and

FIG. 7A is a diagram illustrating various layers within a CNN model.

FIG. 7B is a diagram illustrating exemplary computation stages within a convolutional layer of a CNN model.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well-known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

A CNN model is a specialized feedforward neural network model for processing data having a known, grid-like topology, such as image data. Accordingly, CNN models are commonly used for compute vision and image recognition applications, but they also may be used for other types of pattern recognition such as speech and language processing.

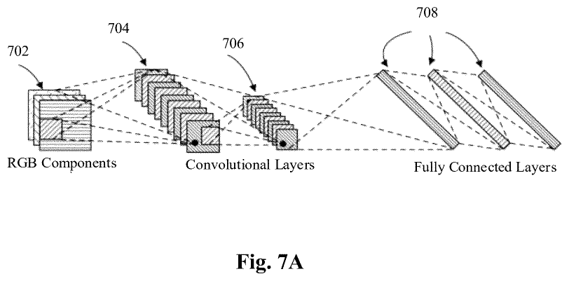

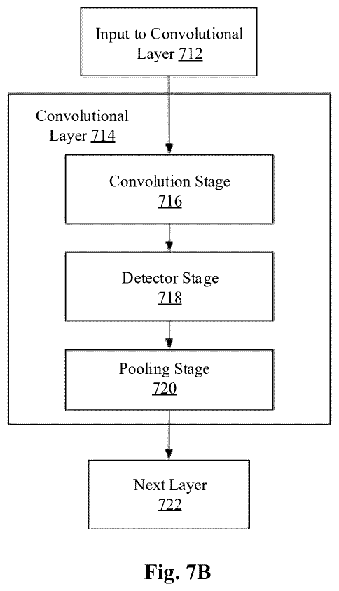

FIG. 7A is a diagram illustrating various layers within a CNN model. As shown in FIG. 7A, an exemplary CNN model used to model image processing can receive input 702 describing Red, Green, and Blue (RGB) components of an input image. The input 702 can be processed by multiple convolutional layers (e.g., first convolutional layer 704, second convolutional layer 706). The output from the multiple convolutional layers may optionally be processed by a set of fully connected layers 708. Neurons in a fully connected layer have full connections to all activations in the previous layer, as previously described for a feedforward network. The output from the fully connected layers 708 can be used to generate an output result from the network. The activations within the fully connected layers 708 can be computed using matrix multiplication instead of convolution. Not all CNN implementations make use of fully connected layers 708. For example, in some implementations the second convolutional layer 706 can generate output for the CNN model.

The convolutional layers are sparsely connected, which differs from traditional neural network configuration found in the fully connected layers 708. Traditional neural network layers are fully connected, such that every output unit interacts with every input unit. However, the convolutional layers are sparsely connected because the output of the convolution of a field is input (instead of the respective state value of each of the nodes in the field) to the nodes of the subsequent layer, as illustrated. The convolutional kernels associated with the convolutional layers perform convolution operations, the output of which is sent to the next layer. The dimensionality reduction performed within the convolutional layers is one aspect that enables the CNN model to scale to process large images.

FIG. 7B is a diagram illustrating exemplary computation stages within a convolutional layer of a CNN model. Input to a convolutional layer 712 of a CNN model can be processed in three stages of a convolutional layer 714. The three stages can include a convolution stage 716, a detector stage 718, and a pooling stage 720. The convolution layer 714 can then output data to a successive convolutional layer. The final convolutional layer of the network can generate output feature map data or provide input to a fully connected layer, for example, to generate a classification value for the input to the CNN model.

In the convolution stage 716 performs several convolutions in parallel to produce a set of linear activations. The convolution stage 716 can include an affine transformation, which is any transformation that can be specified as a linear transformation plus a translation. Affine transformations include rotations, translations, scaling, and combinations of these transformations. The convolution stage computes the output of functions (e.g., neurons) that are connected to specific regions in the input, which can be determined as the local region associated with the neuron. The neurons compute a dot product between the weights of the neurons and the region in the local input to which the neurons are connected. The output from the convolution stage 716 defines a set of linear activations that are processed by successive stages of the convolutional layer 714.

The linear activations can be processed by a detector stage 718. In the detector stage 718, each linear activation is processed by a non-linear activation function. The non-linear activation function increases the nonlinear properties of the overall network without affecting the receptive fields of the convolution layer. Several types of non-linear activation functions may be used. One particular type is the rectified linear unit (ReLU), which uses an activation function defined as ƒ(x)=max(0, x), such that the activation is thresholded at zero.

The pooling stage 720 uses a pooling function that replaces the output of the second convolutional layer 706 with a summary statistic of the nearby outputs. The pooling function can be used to introduce translation invariance into the neural network, such that small translations to the input do not change the pooled outputs. Invariance to local translation can be useful in scenarios where the presence of a feature in the input data is more important than the precise location of the feature. Various types of pooling functions can be used during the pooling stage 720, including max pooling, average pooling, and 12-norm pooling. Additionally, some CNN implementations do not include a pooling stage. Instead, such implementations substitute and additional convolution stage having an increased stride relative to previous convolution stages.

The output from the convolutional layer 714 can then be processed by the next layer 722. The next layer 722 can be an additional convolutional layer or one of the fully connected layers 708. For example, the first convolutional layer 704 of FIG. 7A can output to the second convolutional layer 706, while the second convolutional layer can output to a first layer of the fully connected layers 708.

CNN models have demonstrated record breaking results in almost all computer vision tasks. Regardless of the availability of a large-scale dataset and powerful hardware resources, the leading performance of the CNN models is attributed to a huge number of learnable parameters, even up to hundreds of millions. However, this in turn brings heavy costs of memory, compute and power, which prohibits their broad usages, especially on resource constrained devices. With the drive to make the CNN models be applicable on mobile or embedded or other low power devices, substantial research efforts have been invested for network quantization of the CNN models both in academia and industry.

An extreme quantization solution of the CNN models is 1-bit network quantization, in which parameters of the CNN models are forced to be 1-bit values {−1, 1}. Specifically, basic concepts of the 1-bit network quantization are the following: assuming M={ƒ(Wₗ, Aₗ; Xₗ)|1≤l≤L} is a 32-bit floating-point CNN model (it should be appreciated that the 32-bit floating-point CNN model is just for example, it may also be a 64-bit or 16-bit floating-point CNN model or a Block Floating-Point (BFP)-16 CNN model), where Wₗ is a 32-bit floating-point weight set of a l-th convolutional layer, Xₗ is an input set of the l-th convolutional layer, Aₗ is an activation set of the l-th convolutional layer, and L is the number of convolutional layers in the 32-bit floating-point CNN model M. The 1-bit network quantization aims to convert the 32-bit floating-point CNN model M into a 1-bit CNN model, which has only a quantized weight set Ŵₗ whose entries are composed of αₗB, where B∈{1,−1} and αₗ is a positive scaling factor specific to the l-th convolutional layer. Mathematically, an objective function of the 1-bit network quantization of the 32-bit floating-point CNN model M may be defined as follows:

$${arg min}_{{\hat{W}}_{l}} {‖ {\hat{W}}_{l} - {W}_{l} ‖}_{2}^{2} , {\hat{W}}_{l} = {α}_{l} B , B ∈ \{ 1 , - 1 \} \qquad ( 1 )$$

The optimization of the objective function (1) may be readily solved with for example, a popular Straight-Through Estimator (STE).

As compared with the 32-bit floating-point CNN model, the 1-bit network quantization brings significant storage and latency reductions (32X compression and at most 58× speed-up) by replacing originally time-intensive multiplication operations by cheap bitwise XNOR and Bitcount operations, easing deployment of CNN solutions, especially with specialized AI devices.

Existing 1-bit network quantization solutions including but not limited to Binary-Weight-Network (BWN), DoReFa-Net, XNOR-Net, Ternary-Binary Network (TBN), Loss-aware Binary Network (LBN), Explicit Loss-error-aware Quantization (ELQ), Learned Quantization (LQ)-Net, Differentiable Soft Quantization (DSQ) and Information Retention (IR)-Net, focus on binary quantization scheme designs, aiming to get 1-bit CNN models with high accuracy.

Benefiting from recent great advances on binary network design, modern binary networks have small accuracy drop against full-precision reference models. For single-class or multi-class vision applications like face detection/verification, pedestrian/human detection, etc., the 1-bit CNN models have been popular used as the accuracy drop is negligible (usually less than 1%). However, there is still considerable room for compression and speed-up of the 1-bit CNN models without loss of model accuracy.

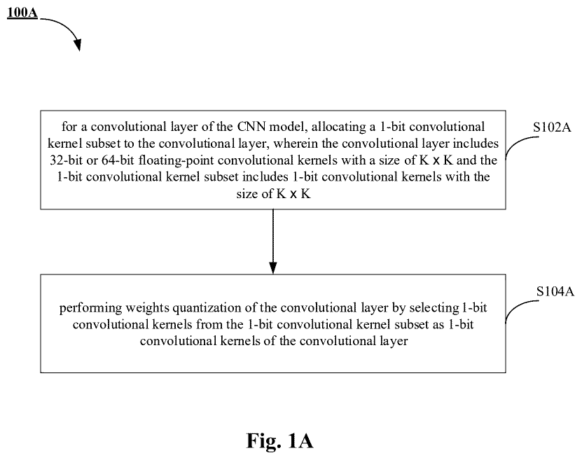

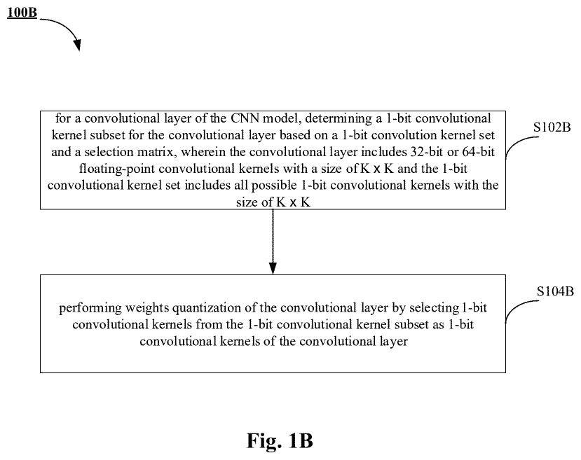

FIG. 1A is a flow diagram illustrating a method 100A for quantizing a CNN model in accordance with some embodiments of the disclosure. As shown in FIG. 1A, the method 100A includes, for a l-th convolutional layer of the CNN model (l is a positive integer): S102A, allocating a 1-bit convolutional kernel subset P to the l-th convolutional layer, wherein the l-th convolutional layer includes 32-bit or 64-bit floating-point convolutional kernels with a size of K×K and the 1-bit convolutional kernel subset Pₗ includes 2^{τ} 1-bit convolutional kernels with the size of K×K, 1≤τ<K×K and both K and τ being positive integers; and S104A, performing weights quantization of the l-th convolutional layer by selecting 1-bit convolutional kernels from the 1-bit convolutional kernel subset Pt as 1-bit convolutional kernels of the l-th convolutional layer.

In some embodiments, the 1-bit convolutional kernel subset Pₗ may be shared to all convolutional layers of the CNN model or specific to the l-th convolutional layer. 1-bit convolutional kernel subsets allocated to different convolutional layers of the CNN model may include the same number of 1-bit convolutional kernels or different numbers of 1-bit convolutional kernels. The 1-bit convolutional kernels of the 1-bit convolutional kernel subset Pₗ may be predefined or randomly selected from a 1-bit convolutional kernel set Uₗ including all possible 1-bit convolutional kernels with the size of K×K or a part of them.

In some embodiments, an objective function of network quantization of the CNN model may be defined as follows:

$${arg min}_{{\hat{W}}_{l}} {‖ {\hat{W}}_{l} - {W}_{l} ‖}_{2}^{2} , {\hat{W}}_{l} ∈ {P}_{l} , {P}_{l} = \{ {w}_{1} , {w}_{2} , … , {W}_{{2}^{N}} \} \qquad ( 2 )$$

wherein Pₗ={w₁, w₂, . . . , w₂_{^{N}}} is the 1-bit convolutional kernel subset allocated to the l-th convolutional layer, Ŵₗ is a quantized weight set of the l-th convolutional layer, and Wₗ is a 32-bit or 64-bit floating-point weight set of the l-th convolutional layer.

In the process of training the CNN model, the 1-bit convolutional kernel subset Pₗ may be refined by replacing one or more 1-bit convolutional kernels in the 1-bit convolutional kernel subset Pₗ with one or more of remaining ones in the 1-bit convolutional kernel set Uₗ.

FIG. 1B is a flow diagram illustrating a method 100B for quantizing the CNN model in accordance with some embodiments of the disclosure. As shown in FIG. 1B, the method 100B includes, for the l-th convolutional layer of the CNN model: S102B, determining the 1-bit convolutional kernel subset Pₗ for the l-th convolutional layer based on the 1-bit convolutional kernel set Up and a selection matrix St; and S104B, performing weights quantization of the l-th convolutional layer by selecting the 1-bit convolutional kernels from the 1-bit convolutional kernel subset Pₗ as the 1-bit convolutional kernels of the l-th convolutional layer.

In some embodiments, the 1-bit convolutional kernel subset Pₗ is determined as follows:

Pₗ=UₗSₗ (3)

wherein Pₗ=[w₁; w₂; . . . ; w₂_{^{τ}}]∈{1,−1}^{(K×K)×2}^{^{τ}} is the 1-bit convolutional kernel subset determined for the l-th convolutional layer, Uₗ=[w₁; w₂} . . . ; w₂_{^{K×K}}]∈{1,−1}^{(K×K)×2}^{^{K×K}} is the 1-bit convolutional kernel set including all possible 1-bit convolutional kernels with the size of K×K, and Sₗ∈{0,1}²^{^{K×K}}^{×2}^{^{τ}} is the selection matrix, which is randomly initialized with the parameter of τ, and is fixed for the l-th convolutional layer.

It should be appreciated that the selection of the 1-bit convolutional kernel subset Pₗ from the 1-bit convolutional kernel set Uₗ as defined by Equation 3 is dependent on permutation of the 1-bit convolutional kernels in the 1-bit convolutional kernel set Uₗ, and it is necessary to permutate the 1-bit convolutional kernels in the 1-bit convolutional kernel set Uₗ as per a predefined permutation rule in order to select the desired 1-bit convolutional kernel subset Pₗ.

In some embodiments, the 1-bit convolutional kernel subset Pₗ is determined as follows:

Pₗ=UₗRSₗ (4)

wherein Pₗ=[w₁; w₂; . . . ; w₂_{^{τ}}]∈{1,−1}^{(K×K)×2}^{^{τ}} is the 1-bit convolutional kernel subset determined for the l-th convolutional layer, Uₗ=[w₁; w₂; . . . ; w₂_{^{K×K}}]={1,−1}^{(K×K)×2}^{^{K×K}} is the 1-bit convolutional kernel set including all possible 1-bit convolutional kernels with the size of K×K, Sₗ∈{0,1}²^{^{K×K}}^{×2}^{^{τ}} is the selection matrix, and R is a permutation matrix selected from a permutation matrix set Rₗ.

In some embodiments, the objective function of network quantization of the CNN model is defined as follows:

$${arg min}_{{\hat{W}}_{l} ∈ {P}_{l}} {‖ {\hat{W}}_{l} - {W}_{l} ‖}_{2}^{2} , {P}_{l} = {U}_{l} R {S}_{l} , R ∈ {R}_{l} \qquad ( 5 )$$

$${\hat{W}}_{l} ∈ {P}_{l} , {P}_{l} = \{ {w}_{1} , {w}_{2} , … , {W}_{{2}^{τ}} \}$$

wherein Rₗ={R∈{0,1}²^{^{K×K}}^{×2}^{^{K×K}}|R×{1}₂_{^{K×K}}={1}₂_{^{K×K}} and R^{T}×{1}₂_{^{K×K}}={1}₂_{^{K×K}}} is the permutation matrix set, Ŵₗ is the quantized weight set of the l-th convolutional layer, and Wₗ is the 32-bit or 64-bit floating-point weight set of the l-th convolutional layer.

As compared with the 1-bit CNN models, the CNN model resulting from the quantization of the method 100A/100B is compressed about K×K/τ times, and accordingly the quantization of the method 100A/100B is called fractional-bit network quantization and the CNN model resulting from the quantization of the method 100A/100B is called fractional-bit CNN model. Specifically, in the 1-bit CNN models, a 1-bit convolutional kernel with the size of K×K needs K×K bits to represent all its weights, and there are a total of 2K×K 1-bit convolutional kernel candidates for the 1-bit convolutional kernel according to the layout of {1,−1} values. In contrast, in the fractional-bit CNN model, the number of 1-bit convolutional kernel candidates for the 1-bit convolutional kernel is forced to be 2^{τ}, 1≤τ<K×K, in average, representing all weights of the 1-bit convolutional kernel with the size of K×K just needs t bits instead of K×K bits.

Extensive experiments indicates that there is no loss of model accuracy of the fractional-bit CNN model as compared with the 1-bit CNN models. Furthermore, the method 100B is a more advanced quantization solution as compared with the method 100A, which formulates the selection of the 1-bit convolutional kernel subset Pₗ as a novel permutation learning problem solved in an end-to-end manner, generating the fractional-bit CNN model with improved accuracy.

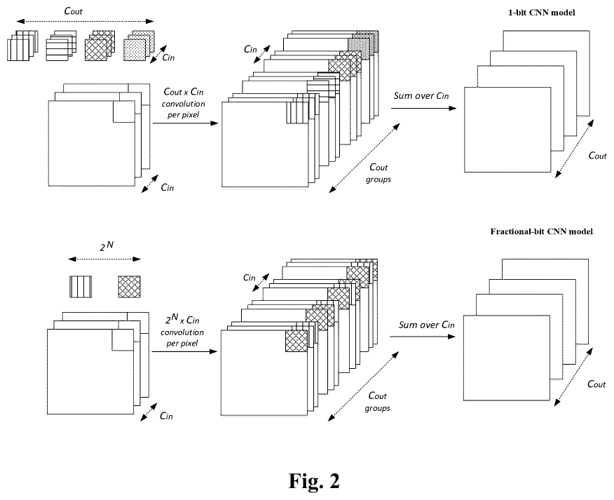

FIG. 2 is a diagram illustrating the speed up of the fractional-bit CNN model against the 1-bit CNN model in accordance with some embodiments of the disclosure. For example, assuming Cₒᵤₜ is the number of output feature channels for the l-th convolutional layer and Cᵢₙ is the number of input feature channels for the l-th convolutional layer. In the 1-bit CNN model, K×K kernel-wise 1-bit convolutional operations per pixel is performed for Cₒᵤₜ×Cᵢₙ times. In contrast, in the fractional-bit CNN model, the K×K kernel-wise 1-bit convolutional operations per pixel is performed for 2^{τ}×Cᵢₙ times as the 2^{τ} 1-bit convolutional kernels are shared to all convolutional kernels each corresponding to one of the output feature channels, 2^{τ}<<Cₒᵤₜ.

Based on the concept of fractional-bit network quantization, a fractional-bit AI accelerator is proposed for deployment of the fractional-bit CNN model resulting from the method 100A/100B. Specifically, the fractional-bit AI accelerator seamlessly bridges properties of the fractional-bit CNN model into HardWare (HW) accelerator architecture designing, making innovations in (1) connections of Processing Engines (PEs) and distributed buffer designs, (2) pre-computing and accumulating working mechanism designs, and (3) compact double-buffer Lookup Table (LUT) designs, for efficient computational flow.

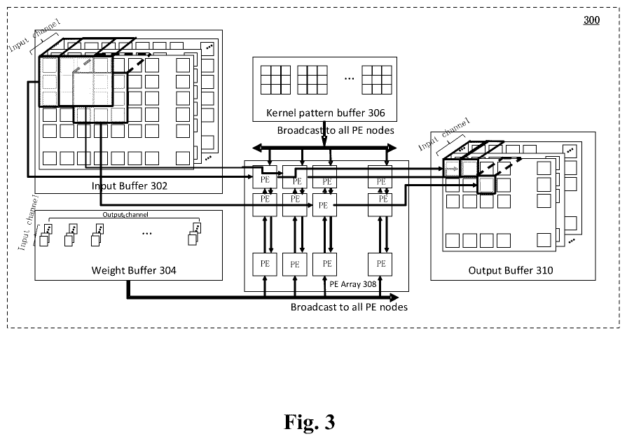

FIG. 3 is a block diagram illustrating a fractional-bit AI accelerator 300 for deployment of a fractional-bit CNN model in accordance with some embodiments of the disclosure. As shown in FIG. 3, the fractional-bit AI accelerator 300 includes an input buffer 302, a weight buffer 304, a kernel pattern butter 306, a PE array 308 and an output buffer 310, wherein: the input buffer 302 is configured to buffer an input image (i.e., respective input feature channels of the input image); the weight buffer 304 is configured to buffer convolutional kernel indexes for a convolutional layer of the fractional-bit CNN model; the kernel pattern buffer 306 is configured to buffer a 1-bit convolutional kernel subset for the convolutional layer of the fractional-bit CNN model, wherein the 1-bit convolutional kernel subset includes 2^{τ} 1-bit convolutional kernels with a size of K×K, 1≤τ<K×K and wherein both K and t are positive integers; the PE array 308 includes one or more PE nodes, each of which is configured to generate convolutional results of an image region of the input image (i.e., input values in every input feature channel of the image region) and 1-bit convolutional kernels corresponding to the convolutional kernel indexes in the 1-bit convolutional kernel subset and output the generated convolutional results to the output buffer 310; the output buffer 310 is configured to buffer convolutional results of respective image regions of the input image and the 1-bit convolutional kernels corresponding to the convolutional kernel indexes.

For example, when the fractional-bit CNN model resulting from the method 100A/100B is deployed in the fractional-bit AI accelerator 300, the weight buffer 304 is configured to buffer the convolutional kernel indexes for the l-th convolutional layer, which are broadcasted to all PE nodes in the PE array 308; the kernel pattern buffer 306 is configured to buffer the 1-bit convolutional kernel subset Pₗ including the 2^{τ} 1-bit convolutional kernels, which are broadcasted to all PE nodes in the PE array 308; and each PE node in the PE array 308 is configured to generate the convolutional results of a certain image region of the input image and the 1-bit convolutional kernels corresponding to the convolutional kernel indexes for the l-th convolutional layer in the 1-bit convolutional kernel subset Pₗ.

In other words, in the fractional-bit AI accelerator 300, inference of the fractional-bit CNN model include the following steps: 1) loading input values of respective image regions of the input image and weights of a certain convolutional layer from corresponding buffers to the PE nodes of the PE array; 2) assigning computation tasks associated with respective image regions of the input image to the PE nodes, which act as parallel computation units, in the PE array; 3) outputting calculation results associated with respective image regions of the input image to the output buffer.

In the fractional-bit AI accelerator 300, as a convolution task associated with the input image is split into multiple sub-tasks associated with respective image regions of the input image that can be conducted in parallel, utilization of hardware resources of the fractional-bit AI accelerator 300 can be maximized.

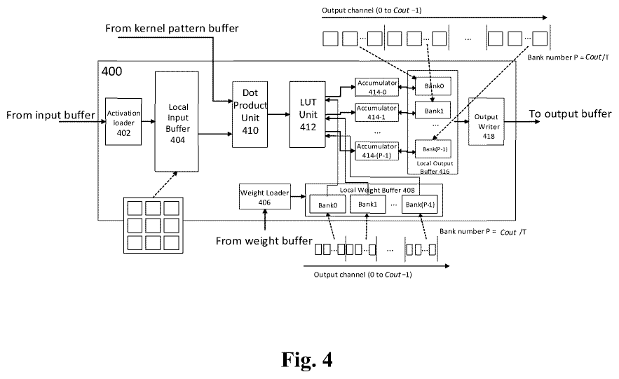

FIG. 4 is a block diagram illustrating a PE node 400 in the fractional-bit AI accelerator shown in FIG. 3 in accordance with some embodiments of the disclosure. As shown in FIG. 4, the PE node 400 includes an activation loader 402, a local input buffer 404, a weight loader 406, a local weight buffer 408, a dot product unit 410, a Lookup Table (LUT) unit 412, at least two accumulator 414, a local output buffer 416 and an output writer 418.

Specifically, when the fractional-bit CNN model resulting from the method 100A/100B is deployed in the fractional-bit AI accelerator 300: the activation loader 402 is configured to load the input values associated with a certain image region of the input image from the input buffer 302 into the local input buffer 404. The weight loader 406 is configured to load the convolutional kernel indexes for the l-th convolutional layer into the local weight buffer 408, wherein convolutional kernel indexes associated with different output feature channels are grouped into P groups, each group includes convolutional kernel indexes associated with T output feature channels which are buffered in a separate bank of the local weight buffer 408. The dot product unit 410 is configured to obtain the 1-bit convolutional kernel subset Pₗ from the kernel pattern buffer 306, obtain the input values associated with the image region of the input image from the local input buffer 404, generate dot products of the input values associated with the image region of the input image and the 2^{τ} 1-bit convolutional kernels in the 1-bit convolutional kernel subset Pₗ, and write the generated dot products into the LUT unit 412. The LUT unit 412 is configured to buffer the dot products from the dot product unit 410, look up dot products associated with the 1-bit convolutional kernels corresponding to the convolutional kernel indexes for the l-th convolutional layer, and output dot products associated with different output channel groups into corresponding accumulators 414. Each of the at least two accumulators 414 is configured to accumulate dot products associated with a same output feature channel and output accumulation results associated with a corresponding group of output feature channels to a corresponding bank of the local output buffer 416. The output writer 418 is configured to read the accumulation results associated with different output feature channels from the accumulators 414 and write them into the output buffer 310.

The architecture of the fractional-bit AI accelerator 300 may be implemented on Field Programmable Gate Arrays (FPGAs), since it can efficiently utilize a large amount of on-chip distributed memories (Block RAMs). Assuming that we need to compute and create LUTs for 3×3 inputs at each input feature channel, both the hardware architecture design and the scheduling strategy require the use of input reservation, i.e., maximizing the lifetime of the input data of each input feature channel inside the PE node. For the 3×3 inputs, all relevant output feature channels are computed before switching to the 3× 3 inputs of a next input feature channel. On the other hand, there is a map relation among the PE nodes and the input feature channels, so that LUTs associated with every input feature channel of a corresponding image region can be kept inside a same PE node without sharing with other PE nodes, thus reducing the complexity of the design.

As shown in FIG. 4, the PE node 400 includes two pipeline designs: pre-computing and accumulating. The pre-computing is implemented by the dot product unit 410 based on two data inputs, one from the kernel pattern buffer 305 shared by all PE nodes and another from the local input buffer 410. Before starting computation, the activation loader 402 loads the input values associated with the image region of the input image into the local input buffer 404. A global addressing logic shared by all PE nodes traverses each item in the kernel pattern buffer 306, sending the 2^{τ} 1-bit convolutional kernels in the 1-bit convolutional kernel subset to the dot product unit 410.

In the PE node 400, a double buffer LUT with one write port and multiple read ports may be used as the LUT unit 412. In each cycle, the dot product unit 410 writes a current dot product to a Write Buffer (WBuffer) of the LUT unit 412, while a corresponding accumulator reads the last dot product from a Read Buffer (RBuffer) of the LUT unit 412 in sequence. After 2^{τ} cycles, the dot products associated with the 2^{τ} 1-bit convolutional kernels in the 1-bit convolutional kernel subset are written into a corresponding accumulator, which generates an accumulation result associated with the image region.

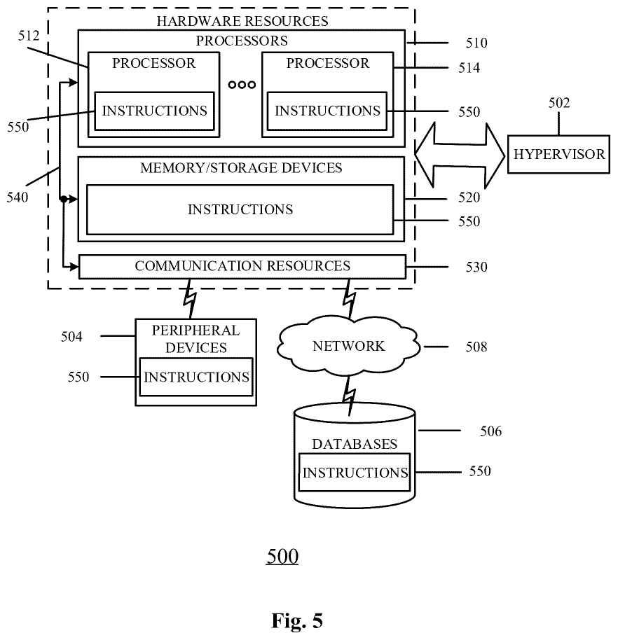

FIG. 5 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 5 shows a diagrammatic representation of hardware resources 500 including one or more processors (or processor cores) 510, one or more memory/storage devices 520, and one or more communication resources 530, each of which may be communicatively coupled via a bus 540. For embodiments where node virtualization (e.g., NFV) is utilized, a hypervisor 502 may be executed to provide an execution environment for one or more network slices/sub-slices to utilize the hardware resources 500.

The processors 510 may include, for example, a processor 512 and a processor 514 which may be, e.g., a central processing unit (CPU), a graphics processing unit (GPU), a tensor processing unit (TPU), a visual processing unit (VPU), a field programmable gate array (FPGA), or any suitable combination thereof.

The memory/storage devices 520 may include main memory, disk storage, or any suitable combination thereof. The memory/storage devices 520 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 530 may include interconnection or network interface components or other suitable devices to communicate with one or more peripheral devices 504 or one or more databases 506 via a network 508. For example, the communication resources 530 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 550 may comprise software, a program, an application, an applet, an app, or other executable code for causing at least any of the processors 510 to perform any one or more of the methodologies discussed herein. The instructions 550 may reside, completely or partially, within at least one of the processors 510 (e.g., within the processor's cache memory), the memory/storage devices 520, or any suitable combination thereof. Furthermore, any portion of the instructions 550 may be transferred to the hardware resources 500 from any combination of the peripheral devices 504 or the databases 506. Accordingly, the memory of processors 510, the memory/storage devices 520, the peripheral devices 504, and the databases 506 are examples of computer-readable and machine-readable media.

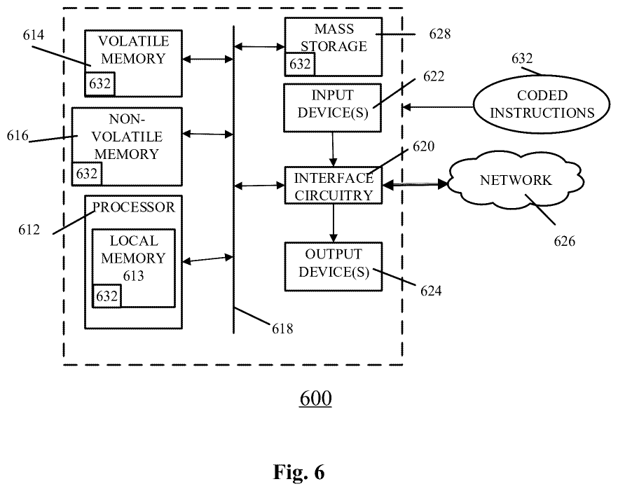

FIG. 6 is a block diagram of an example processor platform in accordance with some embodiments of the disclosure. The processor platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 600 of the illustrated example includes a processor 612. The processor 612 of the illustrated example is hardware. For example, the processor 612 can be implemented by one or more integrated circuits, logic circuits, microprocessors, GPUs, DSPs, or controllers from any desired family or manufacturer. The hardware processor may be a semiconductor based (e.g., silicon based) device. In some embodiments, the processor implements one or more of the methods or processes described above.

The processor 612 of the illustrated example includes a local memory 613 (e.g., a cache). The processor 612 of the illustrated example is in communication with a main memory including a volatile memory 614 and a non-volatile memory 616 via a bus 618. The volatile memory 614 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 616 may be implemented by flash memory and/or any other desired type of memory device. Access to the main memory 614, 616 is controlled by a memory controller.

The processor platform 600 of the illustrated example also includes interface circuitry 620. The interface circuitry 620 may be implemented by any type of interface standard, such as an Ethernet interface, a universal serial bus (USB), a Bluetooth® interface, a near field communication (NFC) interface, and/or a PCI express interface.

In the illustrated example, one or more input devices 622 are connected to the interface circuitry 620. The input device(s) 622 permit(s) a user to enter data and/or commands into the processor 612. The input device(s) can be implemented by, for example, an audio sensor, a microphone, a camera (still or video), a keyboard, a button, a mouse, a touchscreen, a track-pad, a trackball, and/or a voice recognition system.

One or more output devices 624 are also connected to the interface circuitry 620 of the illustrated example. The output devices 624 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuitry 620 of the illustrated example, thus, typically includes a graphics driver card, a graphics driver chip and/or a graphics driver processor.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 626. The communication can be via, for example, an Ethernet connection, a digital subscriber line (DSL) connection, a telephone line connection, a coaxial cable system, a satellite system, a line-of-site wireless system, a cellular telephone system, etc.

For example, the interface circuitry 620 may include a training dataset inputted through the input device(s) 622 or retrieved from the network 626.

The processor platform 600 of the illustrated example also includes one or more mass storage devices 628 for storing software and/or data. Examples of such mass storage devices 628 include floppy disk drives, hard drive disks, compact disk drives, Blu-ray disk drives, redundant array of independent disks (RAID) systems, and digital versatile disk (DVD) drives.

Machine executable instructions 632 may be stored in the mass storage device 628, in the volatile memory 614, in the non-volatile memory 616, and/or on a removable non-transitory computer readable storage medium such as a CD or DVD.

### Additional Notes and Examples

Example 1 includes an Artificial Intelligence (AI) accelerator, comprising: an input buffer configured to buffer an input image; a weight buffer configured to buffer convolutional kernel indexes for a convolutional layer of a Convolutional Neural Network (CNN) model; a kernel pattern buffer configured to buffer a 1-bit convolutional kernel subset for the convolutional layer of the CNN model, wherein the 1-bit convolutional kernel subset comprises 2^{τ} 1-bit convolutional kernels with a size of K×K, 1<<<K×K and wherein K and t are positive integers; a Processing Engine (PE) array comprising one or more PE nodes, each of which is configured to generate convolutional results of an image region of the input image and 1-bit convolutional kernels corresponding to the convolutional kernel indexes in the 1-bit convolutional kernel subset; and an output buffer configured to buffer convolutional results of respective image regions of the input image and the 1-bit convolutional kernels corresponding to the convolutional kernel indexes.

Example 2 includes the AI accelerator of Example 1, wherein different PE nodes generate convolutional results of different image regions of the input image and the 1-bit convolutional kernels corresponding to the convolutional kernel indexes, and a same PE node generates convolutional results of a same image region of the input image and the 1-bit convolutional kernels corresponding to the convolutional kernel indexes.

Example 3 includes the AI accelerator of Example 2, wherein each of the one or more PE nodes comprises: a dot product unit configured to generate dot products of the image region of the input image and the 2^{τ} 1-bit convolutional kernels; a Lookup Table (LUT) unit configured to buffer the dot products of the image region of the input image and the 2^{τ} 1-bit convolutional kernels and look up dot products associated with the 1-bit convolutional kernels corresponding to the convolutional kernel indexes; and at least two accumulators, each of which is configured to accumulate dot products associated with a same output feature channel among the dot products associated with the 1-bit convolutional kernels corresponding to the convolutional kernel indexes.

Example 4 includes the AI accelerator of Example 3, wherein the LUT unit is a double buffer LUT with one write port and at least two read ports.

Example 5 includes the AI accelerator of Example 1, wherein the 1-bit convolutional kernel subset is shared to all convolutional layers of the CNN model.

Example 6 includes the AI accelerator of Example 1, wherein the 1-bit convolutional kernel subset is specific to the convolutional layer of the CNN model.

Example 7 includes the AI accelerator of Example 6, wherein 1-bit convolutional kernel subsets specific for different convolutional layers of the CNN model comprises the same number of 1-bit convolutional kernels.

Example 8 includes the AI accelerator of Example 6, wherein 1-bit convolutional kernel subsets specific for different convolutional layers of the CNN model comprises different numbers of 1-bit convolutional kernels.

Example 9 includes the AI accelerator of Example 1, wherein the 2^{τ} 1-bit convolutional kernels of the 1-bit convolutional kernel subset are randomly selected from a 1-bit convolutional kernel set comprising all possible 1-bit convolutional kernels with the size of K×K or a part of them.

Example 10 includes the AI accelerator of Example 1, wherein an objective function of network quantization associated with the CNN model is defined as follows:

$${arg min}_{{\hat{W}}_{l}} {‖ {\hat{W}}_{l} - {W}_{l} ‖}_{2}^{2} , {\hat{W}}_{l} ∈ {P}_{l} , {P}_{l} = \{ {w}_{1} , {w}_{2} , … , {W}_{{2}^{τ}} \}$$

wherein Pₗ={Ŵ₁, w₂, . . . , w₂_{^{τ}}} is the 1-bit convolutional kernel subset for the convolutional layer of the CNN model, Ŵₗ is a quantized weight set of the convolutional layer of the CNN model, and Wₗ is a 32-bit or 64-bit floating-point weight set of the convolutional layer of another CNN model, which is quantized to the CNN model.

Example 11 includes the AI accelerator of Example 1, wherein the 1-bit convolutional kernel subset for the convolutional layer of the CNN model is determined as follows:

Pₗ=UₗSₗ

wherein Pₗ=[w₁; w₂; . . . ; w₂_{^{τ}}]∈{1,−1}^{(K×K)×2}^{^{τ}} is the 1-bit convolutional kernel subset for the convolutional layer of the CNN model, Uₗ=[w₁; w₂; . . . ; w₂_{^{K×K}}]∈{1,−1}^{(K×K)×2}^{^{K×K}} is a 1-bit convolutional kernel set comprising all possible 1-bit convolutional kernels with the size of K×K, and Sₗ∈{0,1}²^{^{K×K}}^{×2}^{^{τ}} is a selection matrix.

Example 12 includes the AI accelerator of Example 1, wherein the 1-bit convolutional kernel subset for the convolutional layer of the CNN model is determined as follows:

Pₗ=UₗRSₗ

wherein Pₗ=[w₁; w₂; . . . ; w₂_{^{τ}}]∈{1,−1}^{(K×K)×2}^{^{τ}} is the 1-bit convolutional kernel subset for the convolutional layer of the CNN model, Uₗ=[w₁; w₂; . . . ; w₂_{^{K×K}}]∈{1,−1}^{(K×K)×2}^{^{K×K}} is a 1-bit convolutional kernel set comprising all possible 1-bit convolutional kernels with the size of K×K, Sₗ∈{0,1}²^{^{K×K}}^{×2}^{^{τ}} is a selection matrix specific for the convolutional layer of the CNN model, and R is a permutation matrix selected from a permutation matrix set.

Example 13 includes the AI accelerator of Example 12, wherein an objective function of network quantization associated with the CNN model is defined as follows:

$${arg min}_{{\hat{W}}_{l} ∈ {P}_{l}} {‖ {\hat{W}}_{l} - {W}_{l} ‖}_{2}^{2} , {P}_{l} = {U}_{l} R {S}_{l} , R ∈ {R}_{l}$$

$${\hat{W}}_{l} ∈ {P}_{l} , {P}_{l} = \{ {w}_{1} , {w}_{2} , … , {W}_{{2}^{τ}} \}$$

wherein Rₗ={R∈{0,1}²^{^{K×K}}^{×2}^{^{K×K}}|R×{1}₂_{^{K×K}}={1}₂_{^{K×K}} and R^{T}×{1}₂_{^{K×K}}={1}₂_{^{K×K}}} is the permutation matrix set, Wₗ is a quantized weight set of the convolutional layer of the CNN model, and Wₗ is a 32-bit or 64-bit floating-point weight set of the convolutional layer of another CNN model, which is quantized to the CNN model.

Example 14 includes a method for quantizing a Convolutional Neural Network (CNN) model, comprising, for a convolutional layer of the CNN model: determining a 1-bit convolutional kernel subset for the convolutional layer based on a 1-bit convolutional kernel set and a selection matrix, wherein the convolutional layer comprises 32-bit or 64-bit floating-point convolutional kernels with a size of K×K and the 1-bit convolutional kernel set comprises all possible 1-bit convolutional kernels with the size of K×K, K being a positive integer; and performing weights quantization of the convolutional layer by selecting 1-bit convolutional kernels from the 1-bit convolutional kernel set as 1-bit convolutional kernels of the convolutional layer.

Example 15 includes the method of Example 14, wherein the 1-bit convolutional kernel subset is determined as follows:

Pₗ=UₗSₗ

wherein Pₗ=[w₁; w₂; . . . ; w₂_{^{τ}}]∈{1,−1}^{(K×K)×2}^{^{τ}} is the 1-bit convolutional kernel subset, Uₗ=[w₁; w₂; . . . ; w₂_{^{K×K}}]∈{1,−1}^{(K×K)×2}^{^{K×K}} is the 1-bit convolutional kernel set, and Sₗ∈{0,1}²^{^{K×K}}^{×2}^{^{τ}} is the selection matrix.

Example 16 includes the method of Example 14, wherein the 1-bit convolutional kernel subset is determined as follows:

Pₗ=UₗRSₗ

wherein Pₗ=[w₁; w₂; . . . ; w₂_{^{τ}}]∈{1,−1}^{(K×K)×2}^{^{τ}} is the 1-bit convolutional kernel subset, Uₗ=[w₁; w₂; . . . ; w₂_{^{K×K}}]∈{1,−1}^{(K×K)×2}^{^{K×K}} is the 1-bit convolutional kernel set, Sₗ∈{0,1}²^{^{K×K}}^{×2}^{^{τ}} is the selection matrix, and R is a permutation matrix selected from a permutation matrix set.

Example 17 includes the method of Example 16, wherein an objective function of network quantization for the CNN model is defined as follows:

$$\begin{matrix}{arg min}_{{\hat{W}}_{l} ∈ {P}_{l}} {‖ {\hat{W}}_{l} - {W}_{l} ‖}_{2}^{2} , & {P}_{l} = {U}_{l} R {S}_{l} , & R ∈ {R}_{l} \\ & {\hat{W}}_{l} ∈ {P}_{l} & {P}_{l} = \{ {w}_{1} , {w}_{2} , … , {w}_{{2}^{τ}} \}\end{matrix}$$

wherein Rₗ={R∈{0,1}²^{^{K×K}}^{×2}^{^{K×K}}|R×{1}₂_{^{K×K}}={1}₂_{^{K×K}} and R^{T}×{1}₂_{^{K×K}}={1}₂_{^{K×K}}} is the permutation matrix set, Wₗ is a quantized weight set of the convolutional layer, and Wₗ is a 32-bit or 64-bit floating-point weight set of the convolutional layer.

Example 18 includes a computer-readable medium having instructions stored thereon, wherein the instructions, when executed by processor circuitry, cause the processor circuitry to perform the method of any one of Examples 14 to 17.

Example 19 includes an apparatus for a Convolutional Neural Network (CNN), comprising means for performing the method of any one of Examples 14 to 17.

Example 20 includes an apparatus for a Convolutional Neural Network (CNN), comprising: memory having instructions stored thereon; and processor circuitry coupled to the memory, wherein the instructions, when executed by the processor circuitry, cause the processor circuitry to perform the method of any one of Examples 14 to 17.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1-20. (canceled)

21. An Artificial Intelligence (AI) accelerator comprising:
an input buffer to buffer an input image;
a weight buffer to buffer convolutional kernel indexes for a convolutional layer of a Convolutional Neural Network (CNN) model;
a kernel pattern buffer to buffer a 1-bit convolutional kernel subset for the convolutional layer of the CNN model, wherein the 1-bit convolutional kernel subset includes 2^{τ} 1-bit convolutional kernels with a size of K×K, 1≤τ<K×K, and wherein K and τ are positive integers;
instructions;
processor circuitry to be programmed based on the instructions to implement a Processing Engine (PE) array including one or more PE nodes, each of which is to generate convolutional results of an image region of the input image and 1-bit convolutional kernels corresponding to the convolutional kernel indexes in the 1-bit convolutional kernel subset; and
an output buffer to buffer convolutional results of respective image regions of the input image and the 1-bit convolutional kernels corresponding to the convolutional kernel indexes.

22. The AI accelerator of claim 21, wherein different PE nodes generate convolutional results of different image regions of the input image and the 1-bit convolutional kernels corresponding to the convolutional kernel indexes, and a same PE node generates convolutional results of a same image region of the input image and the 1-bit convolutional kernels corresponding to the convolutional kernel indexes.

23. The AI accelerator of claim 22, wherein each of the one or more PE nodes includes:
a dot product unit to generate dot products of the image region of the input image and the 2^{τ} 1-bit convolutional kernels;
a Lookup Table (LUT) unit to buffer the dot products of the image region of the input image and the 2^{τ} 1-bit convolutional kernels and look up dot products associated with the 1-bit convolutional kernels corresponding to the convolutional kernel indexes; and
at least two accumulators, each of which is to accumulate dot products associated with a same output feature channel among the dot products associated with the 1-bit convolutional kernels corresponding to the convolutional kernel indexes.

24. The AI accelerator of claim 23, wherein the LUT unit is a double buffer LUT with one write port and at least two read ports.

25. The AI accelerator of claim 21, wherein the 1-bit convolutional kernel subset is shared to all convolutional layers of the CNN model.

26. The AI accelerator of claim 21, wherein the 1-bit convolutional kernel subset is specific to the convolutional layer of the CNN model.

27. The AI accelerator of claim 26, wherein 1-bit convolutional kernel subsets specific for different convolutional layers of the CNN model include the same number of 1-bit convolutional kernels.

28. The AI accelerator of claim 26, wherein 1-bit convolutional kernel subsets specific for different convolutional layers of the CNN model include different numbers of 1-bit convolutional kernels.

29. The AI accelerator of claim 21, wherein the 2^{τ} 1-bit convolutional kernels of the 1-bit convolutional kernel subset are randomly selected from a 1-bit convolutional kernel set including all possible 1-bit convolutional kernels with the size of K×K or a part of them.

30. The AI accelerator of claim 21, wherein an objective function of network quantization associated with the CNN model is defined as follows:
$${arg min}_{{\hat{W}}_{l}} {‖ {\hat{W}}_{l} - {W}_{l} ‖}_{2}^{2} , {\hat{W}}_{l} ∈ {P}_{l} , {P}_{l} = \{ {w}_{1} , {w}_{2} , … , {w}_{{2}^{τ}} \}$$
wherein Pₗ={w₁, w₂, . . . , w₂_{^{τ}}} is the 1-bit convolutional kernel subset for the convolutional layer of the CNN model, Ŵₗ is a quantized weight set of the convolutional layer of the CNN model, and Wₗ is a 32-bit or 64-bit floating-point weight set of the convolutional layer of another CNN model, which is quantized to the CNN model.

31. The AI accelerator of claim 21, wherein the 1-bit convolutional kernel subset for the convolutional layer of the CNN model is determined as follows:
Pₗ=UₗSₗ
wherein Pₗ=[w₁; w₂; . . . ; w₂_{^{τ}}]∈{1,−1}^{(K×K)×2}^{^{τ}} is the 1-bit convolutional kernel subset for the convolutional layer of the CNN model, Uₗ=[w₁; w₂; . . . ; w₂_{^{K×K}}]∈{1,−1}^{(K×K)×2}^{^{K×K}} is a 1-bit convolutional kernel set including all possible 1-bit convolutional kernels with the size of K×K, and Sₗ∈{0,1}²^{^{K×K}}^{×2}^{^{τ}} is a selection matrix.

32. The AI accelerator of claim 21, wherein the 1-bit convolutional kernel subset for the convolutional layer of the CNN model is determined as follows:
Pₗ=UₗRSₗ
wherein Pₗ=[w₁; w₂; . . . ; w₂_{^{τ}}]∈{1,−1}^{(K×K)×2}^{^{τ}} is the 1-bit convolutional kernel subset for the convolutional layer of the CNN model, Uₗ=[w₁; w₂; . . . ; w₂_{^{K×K}}] E {1,−1}^{(K×K)×2}^{^{K×K}} is a 1-bit convolutional kernel set including all possible 1-bit convolutional kernels with the size of K×K, Sₗ∈{0,1}²^{^{K×K}}^{×2}^{^{τ}} is a selection matrix specific for the convolutional layer of the CNN model, and R is a permutation matrix selected from a permutation matrix set.

33. The AI accelerator of claim 32, wherein an objective function of network quantization associated with the CNN model is defined as follows:
$$\begin{matrix}{arg min}_{{\hat{W}}_{l} ∈ {P}_{l}} {‖ {\hat{W}}_{l} - {W}_{l} ‖}_{2}^{2} , & {P}_{l} = {U}_{l} R {S}_{l} , & R ∈ {R}_{l} \\ & {\hat{W}}_{l} ∈ {P}_{l} & {P}_{l} = \{ {w}_{1} , {w}_{2} , … , {w}_{{2}^{τ}} \}\end{matrix}$$
wherein Rₗ={R∈{0, 1}²^{^{K×K}}^{×2}^{^{K×K}}|R×{1}₂_{^{K×K}}={1}₂_{^{K×K}} and R^{T}×{1}₂_{^{K×K}}={1}₂_{^{K×K}}} is the permutation matrix set, Ŵₗ is a quantized weight set of the convolutional layer of the CNN model, and Wₗ is a 32-bit or 64-bit floating-point weight set of the convolutional layer of another CNN model, which is quantized to the CNN model.

34. A method for quantizing a Convolutional Neural Network (CNN) model, the method comprising:
for a convolutional layer of the CNN model:
determining a 1-bit convolutional kernel subset for the convolutional layer based on a 1-bit convolutional kernel set and a selection matrix, wherein the convolutional layer includes 32-bit or 64-bit floating-point convolutional kernels with a size of K×K and the 1-bit convolutional kernel set includes all possible 1-bit convolutional kernels with the size of K×K, K being a positive integer; and
performing weights quantization of the convolutional layer by selecting 1-bit convolutional kernels from the 1-bit convolutional kernel set as 1-bit convolutional kernels of the convolutional layer.

35. The method of claim 34, wherein the 1-bit convolutional kernel subset is determined as follows:
Pₗ=UₗSₗ
wherein Pₗ=[w₁; w₂; . . . ; w₂_{^{τ}}]∈{1,−1}^{(K×K)×2}^{^{τ}} is the 1-bit convolutional kernel subset, Uₗ=[w₁; w₂; . . . ; w₂_{^{K×K}}]∈{1,−1}^{(K×K)×2}^{^{K×K}} is the 1-bit convolutional kernel set, and Sₗ∈{0,1}²^{^{K×K}}^{×2}^{^{τ}} is the selection matrix.

36. The method of claim 34, wherein the 1-bit convolutional kernel subset is determined as follows:
Pₗ=UₗRSₗ
wherein Pₗ=[w₁; w₂; . . . ; w₂_{^{τ}}]∈{1,−1}^{(K×K)×2}^{^{τ}} is the 1-bit convolutional kernel subset, Uₗ=[w₁; w₂; . . . ; w₂_{^{K×K}}]∈{1,−1}^{(K×K)×2}^{^{K×K}} is the 1-bit convolutional kernel set, Sₗ∈{0,1}²^{^{K×K}}^{×2}^{^{τ}} is the selection matrix, and R is a permutation matrix selected from a permutation matrix set.

37. A non-transitory computer-readable medium comprising instructions to cause processor circuitry to at least:
for a convolutional layer of the CNN model:
determine a 1-bit convolutional kernel subset for the convolutional layer based on a 1-bit convolutional kernel set and a selection matrix, wherein the convolutional layer includes 32-bit or 64-bit floating-point convolutional kernels with a size of K×K and the 1-bit convolutional kernel set includes all possible 1-bit convolutional kernels with the size of K×K, K being a positive integer; and
perform weights quantization of the convolutional layer by selecting 1-bit convolutional kernels from the 1-bit convolutional kernel set as 1-bit convolutional kernels of the convolutional layer.

38. The computer-readable medium of claim 37, wherein the instructions are to cause the processor circuitry to determine the 1-bit convolutional kernel subset as follows:
Pₗ=UₗSₗ
wherein Pₗ=[w₁; w₂) . . . ; w₂_{^{τ}}]∈{1,−1}^{(K×K)×2}^{^{τ}} is the 1-bit convolutional kernel subset, Uₗ=[w₁; w₂; . . . ; w₂_{^{K×K}}]∈{1,−1}^{(K×K)×2}^{^{K×K}} is the 1-bit convolutional kernel set, and Sₗ∈{0,1}²^{^{K×K}}^{×2}^{^{τ}} is the selection matrix.

39. The computer-readable medium of claim 37, wherein the instructions are to cause the processor circuitry to determine the 1-bit convolutional kernel subset as follows:
Pₗ=UₗRSₗ
wherein Pₗ=[w₁; w₂; . . . ; w₂_{^{τ}}]∈{1,−1}^{(K×K)×2}^{^{τ}} is the 1-bit convolutional kernel subset, Uₗ=[w₁; w₂; . . . ; w₂_{^{K×K}}]∈{1,−1}^{(K×K)×2}^{^{K×K}} is the 1-bit convolutional kernel set, Sₗ∈{0,1}²^{^{K×K}}^{×2}^{^{τ}} is the selection matrix, and R is a permutation matrix selected from a permutation matrix set.

40. The computer-readable medium of claim 39, wherein an objective function of network quantization for the CNN model is defined as follows:
$${arg min}_{{{W}^{︵}}_{l} ∈ {P}_{l}} {‖ {{W}^{︵}}_{l} - {W}_{l} ‖}_{2}^{2} , {P}_{l} = {U}_{l} {RS}_{l} , R ∈ {R}_{l}$$
$${{W}^{︵}}_{l} ∈ {P}_{l} , {P}_{l} = \{ {w}_{1} , {w}_{2} , … , {w}_{{2}^{τ}} \}$$
wherein Rₗ={R∈{0,1}²^{^{K×K}}^{×2}^{^{K×K}}|R×{1}₂_{^{K×K}}={1}₂_{^{K×K}} and R^{T}×{1}₂_{^{K×K}}={1}₂_{^{K×K}}} is the permutation matrix set, Ŵₗ is a quantized weight set of the convolutional layer, and Wₗ is a 32-bit or 64-bit floating-point weight set of the convolutional layer.
